(19) United States
(12) Patent Application Publication
(10) Pub. No.: US 2003/0190045 A1
(43) Pub. Date: Oct. 9, 2003

(54) Apparatus and method for protecting privacy while revealing data

(76) Inventors: Bernardo A. Huberman, Palo Alto, CA (US); Tad Hogg, Mountain View, CA (US)

Correspondence Address: HEWLETT-PACKARD COMPANY, Intellectual Property Administration, P.O Box 272400, Fort Collins, CO, 80527-2400, US

(21) Appl. No.: 10/114,763

(22) Filed: Apr. 3, 2002

(51) Int. Cl. H04L 9/00

(52) U.S. Cl. 380/282; 380/30

(57) ABSTRACT

A method of protecting privacy, while revealing data, includes: posting a question; posting a plurality of public key in response to the question, where a product of the public keys matches a value given as part of the question, and where a private key corresponds to one of the public keys; encrypting a message with one of the public keys; sending the encrypted message; and if the encrypted message was encrypted with the public key with the corresponding private key, then decrypting the encrypted message. An apparatus for protecting privacy, while revealing data, includes: a first computer configured to post a question; a second computer configured to post a plurality of public key in response to the question, where a product of the public keys matches a value given as part of the question, and where a private key corresponds to one of the public keys, where the first computer is further configured to encrypt a message with one of the public keys and send the encrypted message, and where the second computer is further configured to decrypt the encrypted message if the encrypted message was encrypted with the public key with the corresponding private key.

### TECHNICAL FIELD

This disclosure relates generally to data collection techniques, and more particularly to an apparatus and method for protecting privacy while revealing data.

### BACKGROUND

The ability to collect and disseminate fine-grained data in the medical field has led to expressions of concern about privacy issues and to public reactions that in some cases have translated into laws. (See, Haim Watzman, Israel splits on rights to genetic privacy, Nature 394, 214, Jul. 16, 1998; see also, David Adam, Data protection law threatens to derail UK epidemiology studies, Nature 411, 509, May 31, 2001). In the case of some European Community nations, strong restrictions have been placed on the ability of those who collect personal data to release it without explicit individual consent.

The coming use of genetic information to personalize medical treatments has the negative flip side of allowing finer-grained distinctions by insurance companies of the individuals concerned. Genetics information introduces a further complication in that information about one person is statistically relevant for their relatives as well, due to their common genetic characteristics. Thus, even if one person is not concerned about revealing genetic information, it may nevertheless be a concern for some relatives.

While these concerns are important, it should be pointed out that the release of medical data can also help the community at large, particularly through epidemiological studies to identify new diseases. In this case, there is a need to balance the social benefit of these studies with the loss of privacy that they seem to entail. (See, Patricia A. Roche and George J. Annas, Protecting Genetic Privacy, Nature Genetics 2, 392, May 2001). The current policy proposals often fail to provide this balance and in many cases put restrictions on data sharing that can be detrimental to the public interest, as in the case of epidemiological studies. In fact, new interpretations of these privacy protection laws seem to preclude even the access to data collected by doctors, and in the United Kingdom, even the names of doctors who already have relevant data for studies cannot be revealed. (See, David Adam, supra).

This makes it seem that countries face two alternatives, full disclosure or full privacy. Neither option seems appealing. On the one hand, full disclosure will likely make individuals more reluctant to use medical services for rather routine problems. On the other hand, full privacy, achieved through anonymous services, limits the range of epidemiological studies by preventing researchers from following the health of particular groups identified through initial contact with the medical community. For instance, it may only be apparent after a study is underway that additional questions about the individuals or their relatives would be appropriate.

An alternative, and simplistic, approach would be to resort to a trusted party or entity that would act as an intermediary between the subjects and the researchers while protecting their privacy. The difficulty with this alternative is that it is hard to find someone or an institution that is satisfactory to or liked by everyone. Worse, it provides a single point of failure, for if this entity were compromised, then all data files could suddenly become public. Even with legal protections, citizens might anticipate that laws could change with time, as in the case of adoption rights, where today it is possible to obtain the identity of parents who gave their children away for adoption at a time when the legal standard offered them anonymity for life.

Therefore, the current approaches and/or technologies are limited to particular capabilities and suffer from various constraints.

### SUMMARY

In an embodiment of the present invention, a method of protecting privacy, while revealing data, includes: posting a question; posting a plurality of public keys in response to the question, where a product of the public keys matches a value given as part of the question, and where a private key corresponds to one of the public keys; encrypting a message with one of the public keys; sending the encrypted message; and if the encrypted message was encrypted with the public key with the corresponding private key, then decrypting the encrypted message.

In another embodiment, an apparatus for protecting privacy, while revealing data, includes: a first computer configured to post a question; a second computer configured to post a plurality of public keys in response to the question, where a product of the public keys matches a value given as part of the question, and where a private key corresponds to one of the public keys, where the first computer is further configured to encrypt a message with one of the public keys and send the encrypted message, and where the second computer is further configured to decrypt the encrypted message if the encrypted message was encrypted with the public key with the corresponding private key.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of illustrating an example method of preserving privacy while revealing data, in accordance with an embodiment of the invention.

FIG. 2 is a block diagram of illustrating additional steps in the example method of FIG. 1.

FIG. 3 is block diagram illustrating an apparatus in accordance with an embodiment of the invention.

FIG. 4 is a flowchart illustrating a method of protecting privacy, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments the invention.

The invention provides a technical solution to the current problem of not being able to preserve private information while revealing data. In an embodiment, the invention allows for investigators (or other suitable persons such as researchers) to have access to data of an individual(s) and to contact the individual for further questioning, while at the same time preserving the full privacy (e.g., identity) of the individual being questioned. An embodiment of the invention relies on zero-knowledge cryptographic techniques developed in the context of secure distributed computation. Additional details on zero-knowledge cryptographic techniques are discussed in, for example, Bruce Schneier, Applied Cryptography, second edition, John Wiley & Sons, 1996, which is fully incorporated herein by reference. Thus, an embodiment of the invention can allow a researcher to issue a survey to a number of individuals who can answer in what effectively amounts to an anonymous fashion, while the individuals can still be tracked over time and queried on additional items without the researcher learning the identity of the subjects. Moreover, the invention does not even require a trusted third party, which for the reasons stated above, is not a suitable solution.

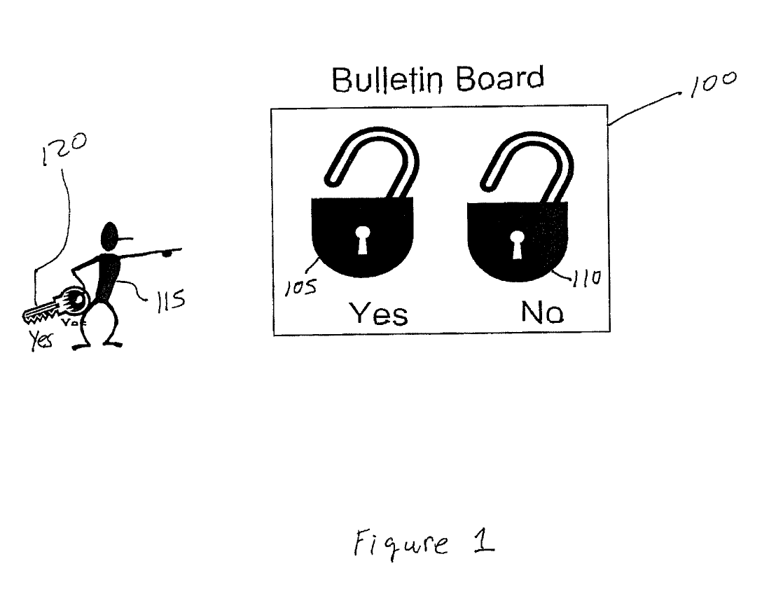

Reference is first made to FIG. 1, in order to describe a method of an embodiment of the invention. The solution provided by the method can be explained in simple terms by resorting to a physical analogy. We first describe this physical analogy and then explain how to implement it computationally.

Consider a bulletin board 100 (typically posted on a data communication network 350 such as the Internet or implemented in a web site) where survey questions are posted for all members of a community to see. As known to those skilled in the art, a bulletin board is typically an electronic message database where people can log in and leave messages and may be implemented in a data communications network by use of computers and associated software. For the sake of explaining an operation of an embodiment of the invention, assume that the answers to these questions are of the form “yes” and “no”, although the method is much more general (e.g., the method can be applied to multiple-choice questions). Each subject 115 answers the question by effectively anonymously “placing” on the bulletin board 100 two unlocked boxes 105 and 110, labeled “yes” and “no”, respectively, with locks designed in such a way that the subject 115 only has the key 120 to the one corresponding to his answer. In the example show in FIG. 1, if the subject answers “yes”, then his/her key 120 corresponds to the box 105 labeled “yes” and can open the box 105 to decrypt and permit reading of messages placed in the box 105. Similarly, a key corresponding to the box 110 can open the box 110 to decrypt and permit reading of messages placed in the box 105. As an example, the locked box 105 in a typical implementation would be any file type encrypted by corresponding public key.

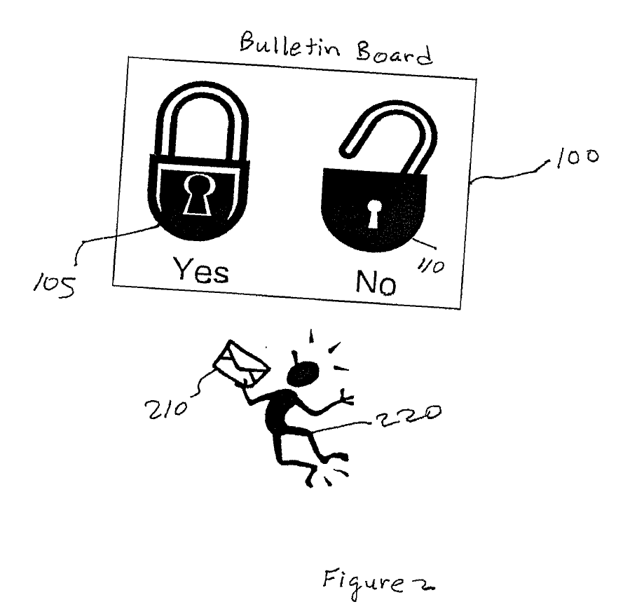

Since no one else knows which of the two keys that the subject 115 has, others, including the researcher asking the question, cannot tell how a given subject 115 responded. And yet, the method permits the researcher to contact each of the responding subjects 115 (respondents) that answered the question in a given way by creating a box 105 that can be unlocked only by members of the selected group, as shown in FIG. 2. When the responding subject 115 posts the yes box 105 and the no box 110 on the bulletin board 100, the researcher is effectively encrypting a message by using the responding subject's public key as represented by the yes box 105.

The researcher 220 can place additional messages (e.g., further questions) in this box 105, and the individual 115 with the key 120 to the locked box 105 can then decrypt the message in the box 105, while those without the key 105 to the locked box 105 will not be able to decrypt the message. The answering individual 115 may, for example, then answer the further questions from the researcher by providing a second set of boxes (e.g., a second set of “yes” box 105 and “no” box 110) and having a private key 120 to the box that corresponds to the answer of the answering individual 115. The researcher can provide additional questions in the second set of boxes which can be unlocked by the answering individual 115, so that the individual 115 can read the further questions from the researcher.

Placing messages 210 in this box 105 and then locking it, also allows communication with members of this group, defined by their answer to the question. Thus the researcher can ask group members further questions. This method need not be restricted to the researcher: the method can also allow members of the group to communicate with each other (e.g., as a chat forum) without them learning the identities of others in the group. All of this occurs in full view of the whole community, but with decrypting abilities possessed only by those who answered in a given fashion.

This method or technique provides a potential solution to the dilemma of protecting privacy or making it public. Notice that the method does not require a trusted third party, although the underlying implementation, which is discussed below, does typically require the user to use standard and tested cryptographic protocols. This trust is analogous from that we put on a locksmith when asking for a copy of our household key, or on the manufacturer of a garage door opener.

A simple application of this technique counts individuals with a given property. All that is required is to post a message with a key (e.g., a public key) requesting an acknowledgment from all members using that key. The number of answers compared to the whole population yields a useful frequency. Another form of panel research would follow a group over time, effectively conducting prospective surveys by simply adding more questions to the bulletin board and watching what happens to the frequencies. This would also allow looking for correlations among members of different groups. That is accomplished by repeating the original procedure in a more refined fashion.

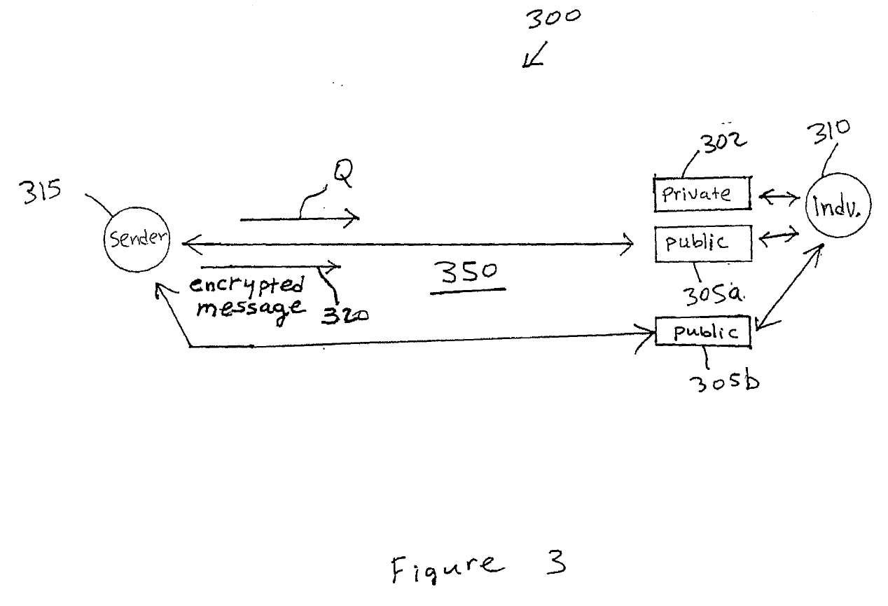

This physical metaphor (i.e., the above method) can actually be implemented and automated in a transparent fashion by using public key cryptographic systems (See, Bernardo A. Huberman, Matt Franklin and Tad Hogg, Enhancing Privacy and Trust in Electronic Communities”, in Proceedings of the ACM Conference on Electronic Commerce (EC99), 78-86 ACM Press” (1999), which is fully incorporated herein by reference). As shown in FIG. 3, this type of cryptographic system 300 rely on a pair of related keys, one secret (private) 302 and one public (key 305a and/or key 305b), associated with each individual participating in a communication. The secret key 302 is needed to decrypt (or sign), while only the public key 305a (or 305b) is needed to encrypt a message (or verify a signature). In the example of FIG. 3, a public key 305a is generated by those wishing to receive encrypted messages 320, and broadcasted so that it can be used by the sender of the message to encode the message 320. In the example of FIG. 3, the sender is using computer 315 (with appropriate software/firmware) to communicate via the network 350. The recipient of this message 320 then uses his own private key 302 in combination with his public key 305a to decrypt the message 320. In the example of FIG. 3, the responding subject is using computer 310 (with appropriate software/firmware) to communicate via the network 350. Popular public key systems are based on the properties of modular arithmetic. In a particular application of an embodiment of the invention, we use the additional property that by constraining the product of two or more public keys 305 to be equal to a specific large number, it is only possible to generate a set of such keys in which only one of the public keys 305 has a corresponding private key 302. This provides the computational basis for the analogy of the locks (box 105 and box 110) described above: each person answers the question by posting two public keys, 305a and 305b, constrained so that their product matches a value given as part of the question. The person can only have a private key 302 for one of the posted public keys 305, and selects the private key 302 corresponding to the answer.

Thus, as an example, a researcher (using computer 315) can ask a question “Q” by posing the question on a bulletin board 100. For purposes of explaining the functionality of an embodiment of the invention, assume, for example, that the question Q is a yes/no question, although an embodiment of the invention can be applied to other types of questions such as multiple-choice questions. To answer a question Q, the responding subject (using computer 310) can post two public keys 305a and 305b, that when multiplied together matches a value given as part of the question Q. The private key 302 corresponds to one of the public keys 305 that is associated with the responding subject's answer to the question Q. Of course, the number of public keys 305 may vary. For example, if a question Q is a multiple choice question with five (5) choices, then the responding subject responds by posting five (5) public keys, but will have only one (1) private key 302 corresponding to one of the five public keys, where the private key corresponds to the responding subject's answer to the question Q.

The sender can then encrypt a message 320 that can be read by the responding subject only if the responding subject answered the question Q in a certain way. For example, the sender may want to send a message 320 to a responding subject that answered “yes” to the question Q. The sender can encrypt the message 320 by using the public key 305a, where the key 305a corresponds to an answer “yes” to the question Q. The sender can send the message 320 directly to the responding subject or post the message 320 to a bulletin board 100 (FIG. 1). If the responding subject answered “yes” to question Q, then the responding subject can use the private key 302 can be used to decrypt the message 320. If the responding subject answered “no” to question Q in the example of FIG. 3, then the private key of the responding subject will correspond to the public key 305b (which is associated with the answer “no”), and therefore, the responding subject will not be able to decrypt the message 320.

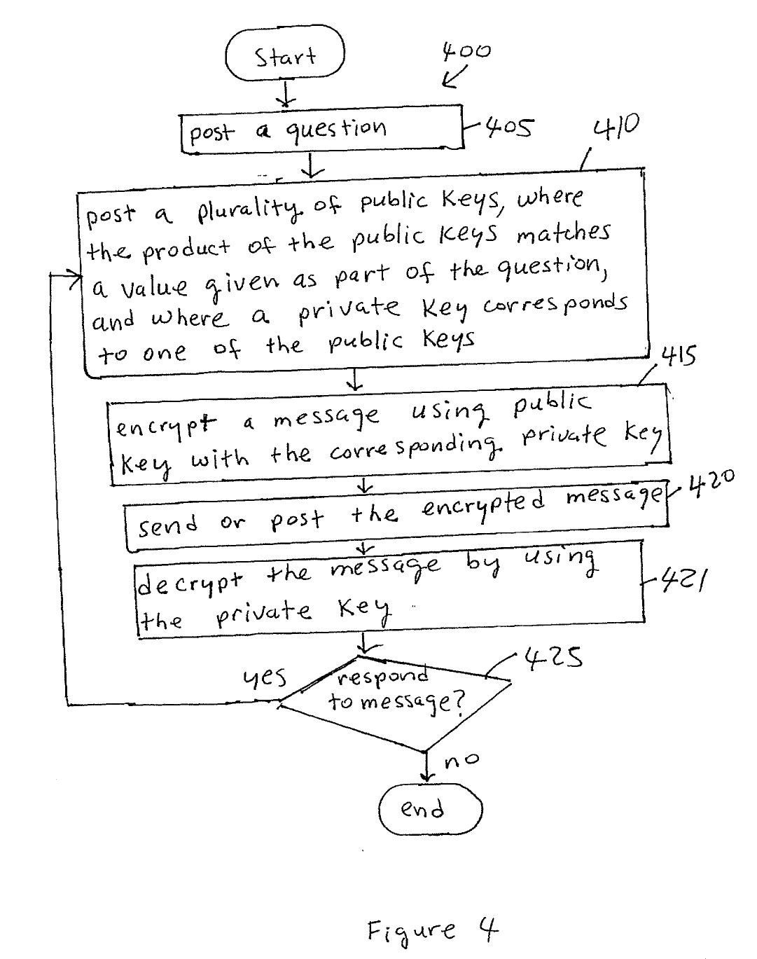

FIG. 4 is a flowchart illustrating a method 400 of protecting privacy while revealing data, in accordance with an embodiment of the invention. The method 400 permits data to be revealed without a requirement of a trusted third party. A researcher (or another suitable individual such as an investigator) can post (405) a question. In one embodiment, the question can be posted on a bulletin board in a data communications network such as the Internet. The question may relate to, for example, a sensitive survey being conducted within an organization, consumer behavior, or epidemiological data being collected for purposes of research. The responding subject(s) can respond by posting (410) a plurality of public keys, where the product of the keys matches a value given as part of the question, and where a private key of the responding subject corresponds to one of the public keys. The private key will corresponds to a public key related to the answer by the responding subject to the question. The researcher can then use one of the public keys posted by the responding subject to encrypt (415) a message. The researcher can then send (420) the encrypted message to the responding subject(s). The researcher can, for example, send the encrypted message directly to the responding subjects or post the encrypted message on the bulleting board. If a responding subject has a private key corresponding to the public key used by the researcher to decrypt the message, then the responding subject can decrypt (421) the encrypted message. As an example, the encrypted message may be a follow-up question to responding subjects who answered in a particular way to the posted question in action (405) above. After decrypting the message in action (421), then the responding subject may further respond in action (425) by posting another set of public keys as similarly described for action (410). A product of the public keys matches a value given as part of the message 320, and where a private key will correspond to one of the public keys. If so, the action (415) through (425) is then repeated. Otherwise, the method 400 ends.

As a further note, studies may be required to determine to what extent laws may be used to protect people from having to reveal their secret keys. Another issue is the size and diversity of the group, enabling people to effectively hide among other members. In some cases, incentives for participation and correct answers can be important and some possible answers have been proposed, like markets for secrets (See, Eytan Adar and Bernardo A. Huberman, A Market for Secrets. FirstMonday, August 2001. http://www.firstmonday.org/issues/issue6_{—}8/adar/index.html, which is fully incorporated herein by reference).

The above-described method provides a third alternative to the dilemma of having to choose between privacy and the public interest. While these two have been part of the public discourse for many years, the new developments in genetic research and information systems raise them to a heightened concern. While the social benefits of novel privacy mechanisms are not usually considered in policy discussions of the use of cryptography, they illustrate an important opportunity for allowing widespread use of these technologies.

The above method allows investigators to access data of an individual(s) and to contact the individual(s) with further questions, while at the same time preserving the privacy of the individual(s). In one embodiment, the invention allows for surveys to be conducted over a data communications network, such as the Internet, and permit the investigators to be able to contact the individual(s) awhile keeping the identity of the individual(s) anonymous. The invention may, for example, permit sensitive surveys to be conducted within organizations or permit collection of epidemiological data over the Internet and across diverse populations. Of course, it is noted that the Internet is chosen as an example of a data communication network 350 because it is a well-established network, and connectivity to the Internet is easily made. However, it is noted that a global communication network, such as the Internet, is not required to practice other embodiments of the invention. A locally provided and maintained communication network may be used in an embodiment of the invention. For example, a cable provider may provide a communications network that is implemented by a web site or “walled garden” that is accessed by its subscribers.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or actions will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method of protecting privacy, while revealing data, the method comprising:
posting a question, wherein the data is revealed without a requirement of a trusted third party;
posting a plurality of public key in response to the question, where a product of the public keys matches a value given as part of the question, and where a private key corresponds to one of the public keys;
encrypting a message with one of the public keys;
sending the encrypted message; and
if the encrypted message was encrypted with the public key with the corresponding private key, then decrypting the encrypted message.

2. The method of claim 1, further comprising:
posting a plurality of another set of public keys in response to the encrypted message, where a product of the another set of public keys matches a value given as part of the encrypted message, and where a private key corresponds to one of the another set of public keys;
encrypting a message with one of the another set of public keys;
sending the encrypted message; and
if the encrypted message was encrypted with the public key with the corresponding private key, then decrypting the encrypted message.

3. The method of claim 1, wherein the question relates to a sensitive survey.

4. The method of claim 1, wherein the question relates to epidemiological data being collected for purposes of research.

5. The method of claim 1, wherein the question relates to consumer behavior.

6. The method of claim 1, wherein the question is posted on a bulletin board in a data communications network.

7. The method of claim 6, wherein the data communications network comprises the Internet.

8. The method of claim 6, wherein the bulletin board is implemented in a web site.

9. An article of manufacture, comprising:
a machine-readable medium having stored thereon instructions to:
post a question, wherein data is revealed without a requirement of a trusted third party;
post a plurality of public key in response to the question, where a product of the public keys matches a value given as part of the question, and where a private key corresponds to one of the public keys;
encrypt a message with one of the public keys;
send the encrypted message; and
if the encrypted message was encrypted with the public key with the corresponding private key, then decrypt the encrypted message.

10. An apparatus for protecting privacy, while revealing data, the apparatus comprising:
means for posting a question, wherein the data is revealed without a requirement of a trusted third party;
coupled to the means for posting a question, means for posting a plurality of public key in response to the question, where a product of the public keys matches a value given as part of the question, and where a private key corresponds to one of the public keys;
coupled to the means for posting the plurality of public keys, means for encrypting a message with one of the public keys;
coupled to the encrypting means, means for sending the encrypted message; and
coupled to the sending means, means for decrypting the encrypted message, if the encrypted message was encrypted with the public key with the corresponding private key.

11. An apparatus for protecting privacy, while revealing data, the apparatus comprising:
a first computer configured to post a question;
a second computer configured to post a plurality of public key in response to the question, where a product of the public keys matches a value given as part of the question, and where a private key corresponds to one of the public keys, where the first computer is further configured to encrypt a message with one of the public keys and send the encrypted message, and where the second computer is further configured to decrypt the encrypted message if the encrypted message was encrypted with the public key with the corresponding private key, wherein the data is revealed without a requirement of a trusted third party.

12. The apparatus of claim 11, wherein the second computer is further configured to post a plurality of another set of public keys in response to the encrypted message, where a product of the another set of public keys matches a value given as part of the encrypted message, and where a private key corresponds to one of the another set of public keys; wherein the first computer is further configured to encrypt a message with one of the another set of public keys, and send the encrypted message; and wherein the second computer is further configured to decrypt the encrypted message if the encrypted message was encrypted with the public key with the corresponding private key.

13. The apparatus of claim 11, wherein the question relates to a sensitive survey.

14. The apparatus of claim 11, wherein the question relates to epidemiological data being collected for purposes of research.

15. The apparatus of claim 11, wherein the question relates to consumer behavior.

16. The apparatus of claim 11, wherein the question is posted on a bulletin board in a data communications network.

17. The apparatus of claim 16, wherein the data communications network comprises the Internet.

18. The apparatus of claim 16, wherein the bulletin board is implemented in a web site.
